(19) United States
(12) Patent Application Publication
(10) Pub. No.: US 2012/0153604 A1
(43) Pub. Date: Jun. 21, 2012

(54) AIRBAG MODULE FOR A VEHICLE OCCUPANT RESTRAINT SYSTEM

(75) Inventors: Stefan Hamels, Mutlangen (DE); Tobias Fechner, Aschaffenburg (DE)

(73) Assignee: TAKATA-PETRI AG

(21) Appl. No.: 13/409,032

(22) Filed: Feb. 29, 2012

Related U.S. Application Data
(63) Continuation of application No. PCT/EP2010/062765, filed on Aug. 31, 2010.

(30) Foreign Application Priority Data
Sep. 2, 2009 (DE) 10 2009 040 246.2

(51) Int. Cl. B60R 21/201; B23P 11/00

(52) U.S. Cl. 280/743.1; 29/428

(57) ABSTRACT

An air bag module for a vehicle occupant restraint system is provided. The air bag module comprising an air bag package, having an air bag which is inflatable for the protection of a vehicle occupant, as well as an envelope in which the air bag is arranged, and a module casing, in which the air bag package is arranged. Here, the envelope of the air bag package comprises a first envelope part and a second envelope part and the first envelope part and the second envelope part have at least one flange section each, which are connected to each other so that at least one envelope flange protruding from the remaining air bag package is formed. It is provided that the envelope flange is spatially fixed on the module casing and/or can be spatially fixed between the module casing and an adjacent structure.

### CROSS-REFERENCE TO A RELATED APPLICATION

This application is a continuation of International Patent Application Number PCT/EP2010/062765, filed on Aug. 31, 2010, which published in German as WO 2011/026849. The foregoing international application is incorporated by reference herein.

### BACKGROUND

The invention relates to an air bag module for a vehicle occupant restraint system as well as a method for producing an air bag module.

It is known to pack an air bag in the folded state into foil and to create a vacuum within the foil, in order to attain a high packing density of the air bag. For example, it is known to fold the air bag in a deep-drawn bottom foil and to weld said bottom foil together with a top foil which is roughly level. Here, the problem can occur that upon unfolding the air bag a great expansion of the bottom foil occurs and said bottom foil tears before the air bag has exited through the top foil. Such an undesired expansion of the bottom foil is caused by the fact that the air bag can solely move out of the air bag module in the area of the top foil and, correspondingly, pushes against the top foil. This causes the bottom foil to be under tension and to be likewise expanded. The tearing of the bottom foil can lead to foil pieces being in an undesired manner hurled into the vehicle interior in an undefined manner. This problem can equally occur when air bag packages are not vacuum-packed.

In the case of a passenger air bag this problem materializes to that effect that between the top foil of the air bag package and the adjacent air bag flap which swings or tears open in the event of deployment and which is typically formed by the instrument panel or a separate cap, a minimum distance is required from the vehicle manufacturers, which typically amounts to approximately 15 mm. The air bag envelope has to be able to expand by this distance without the bottom foil tearing on account of the tensile stress acting here on the bottom foil.

This problem occurs to an increasing degree in the low temperature range, in which the ability of foils to expand is greatly restricted. Foils indeed exist, which are greatly able to expand also in the low temperature range. Such foils are, however, either costly and/or can only to a restricted degree be deep-drawn, which is why they are only to a limited extent suitable for solving the mentioned problem.

### SUMMARY

The object underlying the present invention is to provide an air bag module having an air bag package having an improved safety with respect to an undesired tearing off of the air bag packaging such as e.g. foil. At the same time, a vehicle with such an air bag module as well as a method for producing a corresponding air bag module shall be made available.

It is provided according to an exemplary aspect of the present invention that the envelope flange of the envelope of an air bag package, said envelope flange being formed by the flange sections of a first, lower envelope part and a second, upper envelope part of the air bag package, is spatially fixed on the module casing and/or can be spatially fixed between the module casing and an adjacent structure, for example an instrument panel. The first envelope part is here for example formed by a bottom foil and the second envelope part by a top foil of the air bag package. By the spatial fixing of the envelope flange a tensile stress of the first, lower envelope part is prevented or at least reduced considerably, because the corresponding tensile forces, which in the event of deployment are produced by expansion of the second, upper envelope part, are absorbed by the module casing and/or the adjacent structure. With that, the lower envelope part undergoes at most a small expansion.

At the same time this means that the occurring strains are concentrated in the area of the upper envelope part, that means that essentially the entire expansion is taken on by the upper envelope part, until this upper envelope part finally tears open in a defined manner in the area of a tearing edge. The danger of a failure of the lower envelope part is reduced considerably by this reduction of the strains.

In the specified functionality it further needs to be taken into account that the tearing open of the upper envelope part along a defined tear line is provoked by the sum of vertical and horizontal strains. These are in the area of the tear line reinforced by the invention in such a way that the tear line already tears open upon a small expansion of the upper envelope part, i.e. after a small vertical path in the direction of the air bag flap.

The solution according to the invention thus securely prevents a separation of envelope parts upon the deployment of the air bag, wherein simultaneously an opening of the envelope in a defined manner in the area of the upper envelope part and an unfolding of the air bag in a defined manner due to the defined opening of the envelope are made available. At the same time, on account of the relief of the lower envelope part requirements regarding a minimum distance between the folding package and an adjacent air bag flap can be fulfilled without any difficulties.

The envelope flange of the envelope of the air bag package is formed by connecting a flange section of the first envelope part and a flange section of the second envelope part. The two flange sections are, for example, welded or glued together. A flange section is here particularly a projection, formed plane, which can protrude from the remaining envelope part. Here it can be provided that a flange section has a closed, circumferential geometry, whereby also the envelope flange altogether possesses such a geometry. In other embodiments non-circumferential, for example flap-like structures can also each form a flange section and the envelope flange. Also, multiple flange sections of the first and/or the second envelope part, in particular flange sections which are spaced apart from each other, and envelope flange sections, formed by said envelope parts, can be provided.

In an exemplary embodiment of the invention the envelope flange, in a position laterally protruding from the air bag package, is spatially fixed on the module casing or can be spatially fixed between the module casing and an adjacent structure. The envelope flange thus protrudes laterally from the remaining air bag package, so that fixing it can take place without affecting the actual air bag package. In this context it can be provided that the envelope flange is or can be spatially fixed in the area of a flange of the module casing. A flange of a module casing, by means of which the module casing is, for example, fastened in a vehicle structure such as an instrument panel, offers a wide support for fixing and clamping the envelope flange. Such a clamping can take place with or without separate fixing means.

The envelope flange is spatially fixed on the module casing for example by means of separate or module-integrated fixing elements. For example, bolts of a module screw connection serve for the spatial fixing of the envelope flange. In another embodiment, hooks are formed on the module casing, into which hooks the envelope flange is hung. It can further be provided that the envelope flange can be spatially fixed by fixing elements of the adjacent structure, for example an instrument panel, and/or that the envelope flange can be spatially fixed by positive-locking elements, which serve to connect the module casing to the adjacent structure.

To spatially fix the envelope flange it is in an exemplary embodiment provided that the envelope flange has pre-punched holes, which allow for a passing through of fixing elements, such as for instance hooks and pivots, through such holes.

The first envelope part in an embodiment of the invention forms a housing, in which the folded air bag is arranged. The second envelope part closes the housing formed by the first envelope part. The first and the second envelope part are here formed, for example, by a bottom foil and a top foil, which are welded together on the respective flange section. In particular, the bottom foil is here formed as deep-drawn bottom foil, into which the folded air bag is placed.

The method for producing an air bag module according to an exemplary embodiment of the invention has the following steps:
Arranging an air bag in a first envelope part;
Connecting at least one flange section of the first envelope part with at least one flange section of a second envelope part to form an envelope, in which the air bag is arranged, wherein the two flange sections, which are connected to each other, form at least one envelope flange of the envelope, and wherein the envelope and the air bag form an air bag package;
Arranging the air bag package in a module casing; and
Spatially fixing the envelope flange on the module casing and/or between the module casing and an adjacent structure.

Here, it can be provided that the envelope is evacuated prior to completely connecting the flange sections, so that a vacuum-packed air bag package is made available, which is then arranged in the module casing.

### BRIEF DESCRIPTION OF THE DRAWINGS

The invention will subsequently be explained as an example with reference to the figures of the drawing with the help of multiple exemplary embodiments.

FIG. 1 shows a sectional illustration of a first exemplary embodiment of an air bag module—

FIG. 2 shows a sectional illustration of a second exemplary embodiment of an air bag module.

FIG. 3 shows a sectional illustration of a third exemplary embodiment of an air bag module.

### DETAILED DESCRIPTION

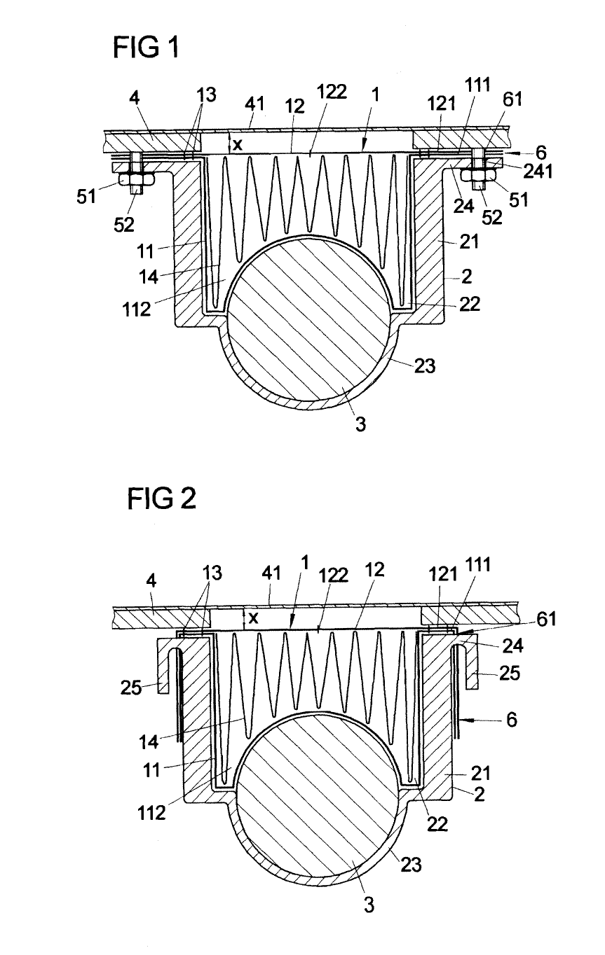

FIG. 1 shows an air bag module, having an air bag package 1, a module casing 2 and a gas generator 3. Via fastening elements 51, 52 the air bag module is connected to an adjacent structure, for example an instrument panel 4 of a vehicle.

The module casing 2 forms a housing 22 for the arrangement of the air bag package 1 by means of side walls 21. The housing 2 furthermore comprises a fastening area 23 for the gas generator 3. In this respect, the illustrated casing 2 at the same time illustrates a gas generator support. It can, however, likewise be provided that the gas generator support is designed as a separate component.

The gas generator is merely illustrated as an example in FIG. 1. Basically any gas generator can be used, where applicable together with a diffuser (not illustrated).

The module casing 2 furthermore forms a flange 24, which serves to fasten the air bag module to the instrument panel 4. The flange 24 has openings 241, which allow for a passing through of connecting elements 52. The connecting elements in the illustrated exemplary embodiment are bolts 52, which are connected to the instrument panel 4 and which are for a connection with the module casing inserted through the openings 241 and fastened by means of nuts 51. Obviously, fastening the module casing 2 and the instrument panel 4 can, however, also take place in a different manner by means of suitable positive-locking and/or force-fit locking connections. For example, it can be provided that the bolts 52 are pre-assembled on or integrated into the module casing 2 and are inserted into openings or recesses of the instrument panel 4.

The air bag package 1 comprises a first envelope part 11 in the form of a deep-drawn bottom foil as well as a second envelope part 12 in the form of a top foil 12, which are connected to each other via one or multiple welding seams 13. The deep-drawn bottom foil 11 here forms a housing 112, which serves to arrange the folded air bag 14. The housing 112 is closed by the top foil 12, which is essentially formed plane. The top foil 12 has one or multiple tear lines, along which the top foil tears open upon inflating the air bag 14 in the event of deployment in a defined manner when a specific expansion is reached. Such a tear line 122 is schematically illustrated in FIG. 1.

To connect the bottom foil 11 and the top foil 12 flange sections 111 of the bottom foil 11 and 121 of the top foil 12 are provided, which lie plane one on top of the other and in the area of which the welding seams 13 to connect the bottom foil 11 and the top foil 12 are arranged. The flange sections 112, 121 which are connected to each other form an envelope flange 6 of the air bag package 1. This envelope flange 6 protrudes from the rest of the air bag package 1.

The air bag package 1 is in an embodiment vacuum-packed, i.e. a vacuum is created within the envelope 11, 12 to attain a high packing density of the air bag 14. In other embodiments the air bag package is not vacuum-packed.

To fix the envelope flange 6 said envelope flange 6 has pre-punched holes 61. The foil flange 6 is in the area of the pre-punched holes 61 pushed over the bolts 52 and is clamped between the flange 24 of the module casing 2 and the instrument panel 4 when the nuts 51 are tightened.

After connecting the module casing 2 to the instrument panel 4 the envelope flange 6 is spatially fixed between the module casing 2 and the instrument panel 4. This causes that in the event of deployment the entire expansion is taken on by the top foil 12, wherein the bottom foil 11 undergoes no expansion or only an expansion to a minor degree. The expansion of the top foil 12 takes place until said top foil 12 finally tears open on one or multiple tear lines 112 in a defined manner.

In this context it is pointed out that the instrument panel 4 has a smaller wall thickness in a cap area 41, located above the air bag package 1, and is in this respect spaced apart from the top foil 12. This distance X is normally determined by the vehicle manufacturer and can amount to approximately 15 mm. On account of the concentration of the occurring strains on the top foil 12, provided by the spatial fixing of the envelope flange 6, it is attained that the top foil 12 tears before it enters into contact with the cap area 41 of the instrument panel 4. However, it can in other exemplary embodiments also be provided that the top foil 12 only tears after it has exited the instrument panel 4. In this way, as the occurring strains are essentially absorbed by the top foil 12 anyway, it can be acceptable that the top foil only tears at a later time, after it has broken through the cap 41.

The housing 21, formed by the walls 21 of the module casing 2 can for example be formed cuboid-shaped or cylindrical, depending on whether the module casing 2 itself is circular or rectangular in cross section. Correspondingly, the envelope flange 6 can be formed as circumferential envelope flange or instead it can have multiple flap-like envelope flange areas. In any case it is provided that the bottom foil 11 on at least two sides, possibly also on three or four sides or circumferentially is clamped between the module casing 2 and the instrument panel 4 so that said bottom foil 11 in the event of deployment undergoes no or only a minor expansion.

The bottom foil 11 and the top foil 12 can be made of the same or, alternatively, of different material. It is further pointed out that the gas generator 3 in the illustrated exemplary embodiment is not arranged within the envelope of the air bag package, but instead is flanged onto said air bag package. The inflow of gas from the gas generator 3 into the air bag 14 takes place here with a local destruction of the bottom foil 11 in the areas of the gas inflow. It can, however, equally be provided that the gas generator 3 is likewise arranged within the air bag package 1.

FIG. 2 shows a modification of the exemplary embodiment of FIG. 1, in which the spatial fixing of the envelope flange does not take place between the module casing 2 and the instrument panel 4 but instead solely on the module casing 2. This has the advantage that the fixing and clamping can take place in the course of the assembly of the air bag module. In the exemplary embodiment of FIG. 1 the clamping of the envelope flange 6 takes place only upon installation of the air bag modules on the instrument panel 4.

In the exemplary embodiment of FIG. 2 the module casing 2 has at least two hooks 25, into which the envelope flange 6 is hung via punched windows 61. For this purpose, it is for example according to FIG. 2 provided that the flange 24 forms hooks 25, bent downwards, on its outer side turned away from the air bag package 1. Into these hooks 25 then the welded flange sections 111, 121 or the envelope flange 6 formed by said flange sections 111, 121 is hung by means of pre-punched holes. Apart from that, the exemplary embodiment of FIG. 2 corresponds to the exemplary embodiment of FIG. 1.

In the event of deployment and, with that, upon opening the air bag package 14 the foil flange surfaces 111, 121, which are connected to each other, are held on the casing by the hooks 25. An expansion of the bottom foil 12 is thus in turn limited.

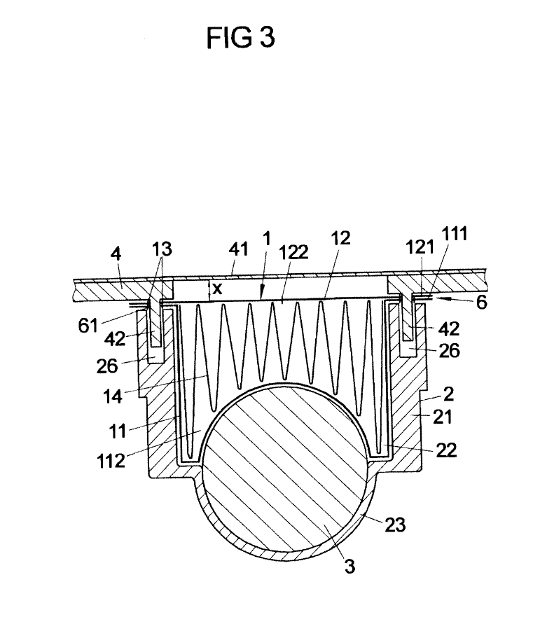

In the exemplary embodiment of FIG. 3, connecting the instrument panel 4 to the module casing 2 takes place by means of hooks or screw connections, which are not illustrated. For fastening the foil on the instrument panel 4 fixing elements 42 in the form of pins and/or hooks and/or strips or pivots are provided, which are schematically illustrated in FIG. 3 and which project into corresponding openings 26 of the module casing 2. The welded flange surfaces 111, 121 in turn possess punched holes 61. Upon installation of the air bag module in the instrument panel 4 the fixing elements 42 of the instrument panel 4 go through the holes 61 of the foil flange 6 and in this manner spatially fix said foil flange 6. Apart from that, the exemplary embodiment of FIG. 3 corresponds to the exemplary embodiment of FIG. 1.

In the event of deployment and, with that, upon opening the air bag package the foil flange surfaces 111, 121 and, with that, the foil flange 6 are fixed in their position by the fixing elements 42, so that in turn an expansion of the bottom foil 11 is prevented or limited.

The exemplary embodiments of FIGS. 1 to 3 can also be combined. For example, in the exemplary embodiment of FIG. 1 additionally hooks for hanging in the envelope flange 6 on the module casing 2 and/or additional fixing elements according to FIG. 3 can be provided.

The production of the specified air bag module can, for example, take place in the following manner. First, the folded air bag is arranged in the deep-drawn bottom foil 11. Subsequently, the flange section 121 of the top foil is laid upon the flange section 111 of the bottom foil 11 and/or pre-fixed onto said flange section 111, whereby an envelope is formed. Subsequently, the envelope is evacuated. Now, the flange section 111 of the bottom foil 11 and the flange section 121 of the top foil are welded together, so that the envelope and the air bag form a vacuum-packed air bag package. Here, it can be provided that prior to the evacuation of the envelope the two flange sections 121, 111 are already partially welded, wherein a complete welding takes place only after evacuating. In other embodiment variants one refrains from an evacuation of the envelope.

The air bag package is then arranged in the module casing 12. Subsequently, a spatial fixing of the envelope flange 6 on the module casing 2 and/or between the module casing and an adjacent structure takes place, as illustrated as an example with the help of FIGS. 1 to 3.

The invention is in its embodiment not restricted to the illustrated exemplary embodiments, which are merely to be understood as an example. For example, the illustrated fixings of the envelope flange on the module casing or between the module casing and the instrument panel can be combined with each other. Furthermore, the specified air bag module can instead of to an instrument panel also be connected to another adjacent vehicle structure. The principles of the present inventions can in this respect be transferred to other kinds of air bag modules than passenger air bag modules. Furthermore, the module casing, the ways of spatially fixing the envelope flange on the module casing or between the module casing and the adjacent structure as well as the illustrated air bag package are merely to be understood as an example. This also applies to the merely schematically indicated manner of folding the air bag in the air bag package.

This priority application, German Patent Application Number 10 2009 040 246.2, filed Sep. 2, 2009 is incorporated by reference herein.

1. An air bag module for a vehicle occupant restraint system, comprising
an air bag package, having an air bag which is inflatable for the protection of a vehicle occupant as well as an envelope, in which the air bag is arranged, and
a module casing, in which the air bag package is arranged, wherein
the envelope of the air bag package comprises a first, lower envelope part and a second, upper envelope part,
the first envelope part and the second envelope part have at least one flange section each, which are connected to each other so that at least one envelope flange protruding from the remaining air bag package is formed, and
the envelope flange is spatially fixed on the module casing and/or can be spatially fixed between the module casing and an adjacent structure.

2. The air bag module according to claim 1, wherein the envelope flange in a position laterally protruding from the air bag package is spatially fixed on the module casing and/or can be spatially fixed between the module casing and an adjacent structure.

3. The air bag module according to claim 1, wherein the envelope flange in the area of a flange of the module casing is or can be spatially fixed.

4. The air bag module according to claim 1, wherein the envelope flange is spatially fixed by means of separate or module-integrated fixing elements on the module casing.

5. The air bag module according to claim 4, wherein the module casing forms hooks on its outer side turned away from the air bag package, into which hooks the envelope flange is hung.

6. The air bag module according to claim 1, wherein the envelope flange can be spatially fixed by fixing elements of the adjacent structure.

7. The air bag module according to claim 1, wherein the envelope flange can be spatially fixed by positive-locking elements, which serve to connect the module casing to the adjacent structure.

8. The air bag module according to claim 1, wherein the envelope flange has multiple pre-punched holes for fixing, which allow for a passing through of fixing elements.

9. The air bag module according to claim 1, wherein the envelope flange can be fixed between the module casing and an adjacent structure by means of clamping, without additional fixing means.

10. The air bag module according to claim 1, wherein the air bag module is a passenger air bag module and the adjacent structure, which together with the module casing serves for the spatial fixing of the envelope flange, is formed by an instrument panel.

11. The air bag module according to claim 1, wherein the second envelope part has at least one tearing edge, along which the second envelope part tears open in the event of deployment.

12. The air bag module according to claim 1, wherein the first envelope part forms a housing, in which the folded air bag is arranged, and the second envelope part closes the housing formed by the first envelope part.

13. The air bag module according to claim 1, wherein the first envelope part and the second envelope part are formed by a bottom foil and a top foil, which are welded together on the respective flange sections.

14. The air bag module according to claim 1, wherein the air bag is vacuum-packed in the envelope.

15. A method for producing an air bag module for a vehicle occupant restraint system with the steps:
Arranging an air bag in a first envelope part;
Connecting at least one flange section of the first envelope part with at least one flange section of a second envelope part to form an envelope, in which the air bag is arranged, wherein the two flange sections, which are connected to each other, form at least one envelope flange of the envelope, and wherein the envelope and the air bag form an air bag package;
Arranging the air bag package in a module casing; and
Spatially fixing the envelope flange on the module casing and/or between the module casing and an adjacent structure.
